(19) United States
(12) Patent Application Publication
(10) Pub. No.: US 2025/0187605 A1
(43) Pub. Date: Jun. 12, 2025

(54) AUTOMOBILE AND CONTROL METHOD OF AUTOMOBILE

(71) Applicant: TOYOTA JIDOSHA KABUSHIKI KAISHA, Toyota-shi (JP)

(72) Inventors: Seiji MASUNAGA, Toyota-shi (JP); Yasuhiro HIASA, Toyota-shi (JP)

(73) Assignee: TOYOTA JIDOSHA KABUSHIKI KAISHA, Toyota-shi (JP)

(21) Appl. No.: 18/937,468

(22) Filed: Nov. 5, 2024

(30) Foreign Application Priority Data
Dec. 8, 2023 (JP) 2023-208024

(51) Int. Cl. B60W 30/182; B60W 10/04; B60W 10/10; B60W 10/18; B60W 60/00

(52) U.S. Cl. CPC B60W 30/182; B60W 10/04; B60W 10/10; B60W 10/18; B60W 60/001

(57) ABSTRACT

An automobile including a surroundings recognition device, a drive device, an automatic gear change device, a brake device, and a controller is provided. The surroundings recognition device is configured to acquire information on surroundings of a vehicle. The controller is configured to control at least the drive device, the automatic gear change device, and the brake device such that the automobile travels by autonomous driving using information from the surroundings recognition device. The controller is configured to prohibit the use of a predetermined low gear stage on a low-speed side in the automatic gear change device when the automobile travels by autonomous driving using a predetermined travel mode.

### CROSS-REFERENCE TO RELATED APPLICATION

This application claims priority to Japanese Patent Application No. 2023-208024 filed on Dec. 8, 2023, incorporated herein by reference in its entirety.

### BACKGROUND

### 1. Technical Field

This disclosure relates to an automobile and a control method of the automobile, and particularly to an automobile that includes an automatic gear change device and is capable of autonomous driving.

### 2. Description of Related Art

An automobile of this type has been hitherto proposed in which, to alleviate a gear change during autonomous driving control compared with during manual driving, when an acceleration or deceleration request is predicted, gear change lines of an automatic transmission are changed such that an upshift gear change line after the change is on a higher vehicle speed side and that a downshift gear change line after the change is on a larger accelerator operation amount side (e.g., see Japanese Unexamined Patent Application Publication No. 2019-111994). Thus controlled, this automobile makes it less likely to experience a sense of busyness and a shock attributable to a gear change of the automatic transmission during autonomous driving.

### SUMMARY

Although in the above-described automobile, the gear change lines are changed during autonomous driving so as to shift the upshift gear change line toward the higher vehicle speed side and the downshift gear change line toward the larger accelerator operation amount side, since a low gear stage, particularly a first gear stage is also used, a strong gear change shock occurs at the time of an upshift from the first gear stage or a downshift to the first gear stage with a high gear ratio. During autonomous driving, the driver, who does not perform driving operations, has higher sensory sensitivity to a gear change shock and thus experiences a stronger gear change shock.

In view of the above, this disclosure discloses an automobile and a control method of the automobile that reduce a gear change shock experienced by a driver during autonomous driving.

A first aspect of this disclosure relates to an automobile including a surroundings recognition device, a drive device, an automatic gear change device, a brake device, and a controller. The surroundings recognition device is configured to acquire information on surroundings of a vehicle. The controller is configured to control at least the drive device, the automatic gear change device, and the brake device such that the automobile travels by autonomous driving using information from the surroundings recognition device. The controller is configured to prohibit the use of a predetermined low gear stage on a low-speed side in the automatic gear change device when the automobile travels by autonomous driving using a predetermined travel mode.

The automobile of the first aspect as described above includes the controller that controls at least the drive device, the automatic gear change device, and the brake device such that the automobile travels by autonomous driving using information from the surroundings recognition device that acquires information on the surroundings of a vehicle. This controller prohibits the use of the predetermined low gear stage on the low speed side in the automatic gear change device when the automobile travels by autonomous driving using the predetermined travel mode. Thus, when driving autonomously using the predetermined travel mode, the automobile of the first aspect as described above can avoid a gear change shock at the time of an upshift from the predetermined low gear stage or a downshift to the predetermined low gear stage. As a result, a gear change shock experienced by the driver during autonomous driving can be reduced.

In the automobile of the first aspect of this disclosure, the surroundings recognition device may have one or more than one among a camera, a millimeter-wave radar, a quasi-millimeter-wave radar, an infrared laser radar, and a sonar. In the automobile of the first aspect of this disclosure, the predetermined travel mode may be a travel mode other than a sport mode. This is based on the sport mode being a travel mode for enjoying acceleration and gear change shocks. In the automobile of the first aspect of this disclosure, the predetermined low gear stage may be a first gear stage.

Since a gear change shock at the time of an upshift from the first gear stage and a gear change shock at the time of a downshift to the first gear stage are stronger than gear change shocks between other gear stages, the automobile configured as described above can avoid stronger gear change shocks by prohibiting the use of the first gear stage.

In the automobile of the first aspect of this disclosure, the controller may permit a skipping upshift in the automatic gear change device when the automobile travels by autonomous driving using the predetermined travel mode. Examples of skipping upshifts include an upshift from a second gear stage to a fourth gear stage and an upshift from the second gear stage to a fifth gear stage.

The automobile configured as described above can reduce the number of times of gear changes in the automobile and reduce gear change shocks.

A second aspect of this disclosure relates to a control method of an automobile including a surroundings recognition device configured to acquire information on the surroundings of a vehicle, a drive device, an automatic gear change device, and a brake device. This control method: (i) controls at least the drive device, the automatic gear change device, and the brake device such that the automobile travels by autonomous driving using information from the surroundings recognition device; and (ii) prohibits the use of a predetermined low gear stage on a low-speed side in the automatic gear change device when the automobile travels by autonomous driving using a predetermined travel mode.

In the automobile including the surroundings recognition device configured to acquire information on the surroundings of a vehicle, the drive device, the automatic gear change device, and the brake device, the control method of the automobile of the second aspect as described above: (i) controls at least the drive device, the automatic gear change device, and the brake device such that the automobile travels by autonomous driving using information from the surroundings recognition device; and (ii) prohibits the use of the predetermined low gear stage on the low speed side in the automatic gear change device when the automobile travels by autonomous driving using the predetermined travel mode. Thus, when the automobile is driving autonomously using the predetermined travel mode, the control method of the automobile of the second aspect as described above can avoid a gear change shock at the time of an upshift from the predetermined low gear stage or a downshift to the predetermined low gear stage. As a result, a gear change shock experienced by the driver during autonomous driving can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration view showing an overview of the configuration of an automobile as one embodiment of this disclosure;

FIG. 2 is an explanatory view showing one example of a gear change chart of the automobile;

FIG. 3 is a flowchart showing one example of a gear change selection process relating to a gear change of an automatic gear change device that is executed by a main ECU installed in the automobile;

FIG. 4 is an explanatory view showing one example of a gear change chart when gear changes to and from a first gear stage are prohibited in the gear change chart shown in FIG. 2;

FIG. 5 is a flowchart showing one example of a gear change selection process in the case of the gear change chart shown in FIG. 4 in which gear changes to and from the first gear stage are prohibited; and

FIG. 6 is an explanatory view showing one example of a gear change chart when gear changes to and from the first gear stage are prohibited and a skipping upshift from second gear to fourth gear is permitted in the gear change chart shown in FIG. 2.

### DETAILED DESCRIPTION OF EMBODIMENTS

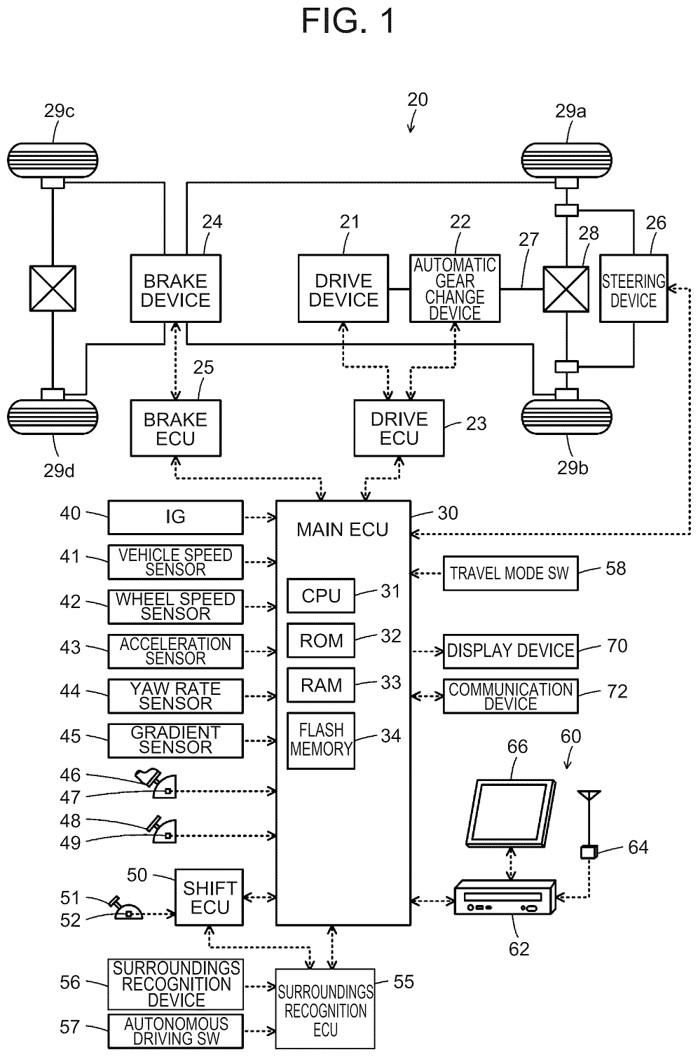

Next, an embodiment for implementing this disclosure will be described. FIG. 1 is a configuration view showing an overview of the configuration of an automobile 20 as one embodiment of this disclosure. As shown, the automobile 20 of the embodiment includes a drive device 21, an automatic gear change device 22, a brake device (braking device) 24, a steering device 26, and a main electronic control unit (hereinafter referred to as a “main ECU”) 30.

The drive device 21 is configured as a device that drives an input shaft of the automatic gear change device 22 to rotate, and corresponds to, for example, a device that includes an engine and a fuel tank and makes the automobile 20 an ordinary engine-equipped automobile, a device that includes a motor, an inverter, and a battery and makes the automobile 20 a battery electric vehicle, a device that includes an engine, a fuel tank, a motor, an inverter, and a battery and makes the automobile 20 a hybrid electric vehicle, a device that includes a hydrogen tank, a fuel cell, a motor, and an inverter and makes the automobile 20 a fuel cell electric vehicle, etc.

The automatic gear change device 22 includes, for example, a torque converter, a six-speed automatic transmission, and a hydraulic circuit (not shown). The torque converter is configured as an ordinary fluidic conduction device, and transmits motive power of an input shaft to an input shaft of the automatic transmission after amplifying the torque or transmits the motive power as is without amplifying the torque. The automatic transmission is connected to the torque converter and a driveshaft 27, and has a plurality of planetary gears and a plurality of hydraulically driven friction-engagement elements (a clutch, a brake). The driveshaft 27 is coupled to drive wheels 29a, 29b through a differential gear 28. The automatic transmission transmits the motive power between the torque converter and the driveshaft 27 by forming forward stages from first gear to sixth gear and a reverse stage, for example, through engagement and disengagement of the plurality of friction-engagement elements.

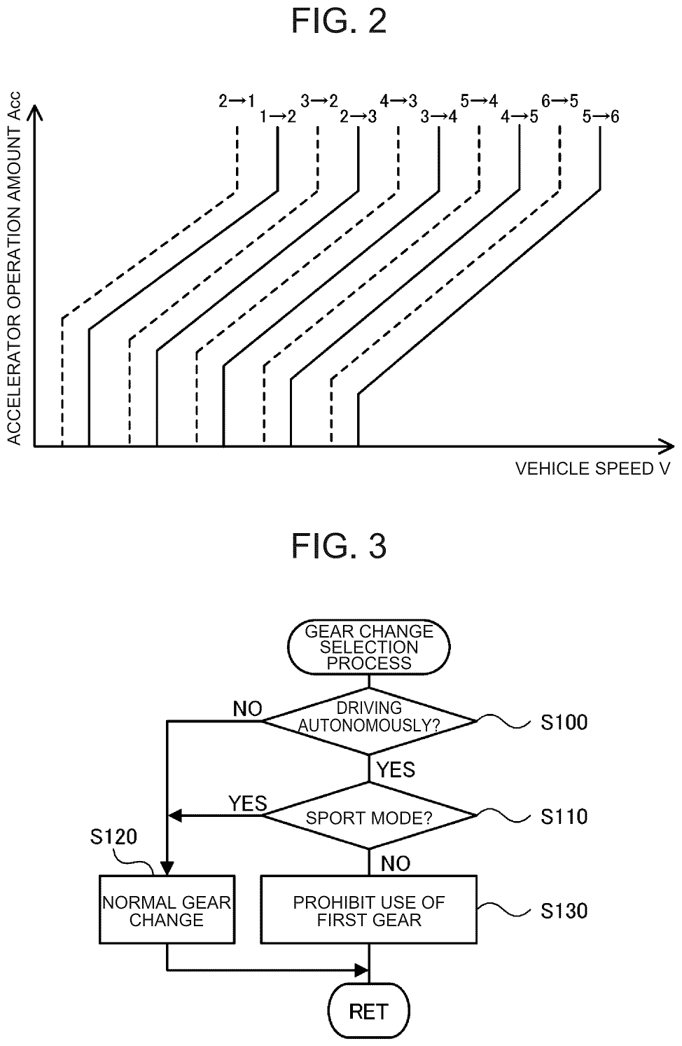

The driving of the drive device 21 and the automatic gear change device 22 is controlled by a drive device electronic control unit (hereinafter referred to as a “drive ECU”) 23. While this is not shown, the drive ECU 23 includes a microcomputer having a CPU, an ROM, an RAM, a flash memory, input and output ports, and a communication port. Signals from various sensors required to control the operation of the drive device 21 and signals from various sensors required to control the gear change of the automatic gear change device 22 are input into the drive ECU 23 through the input port. Various control signals for controlling the operation of the drive device 21, various control signals for controlling the driving of the automatic gear change device 22, etc. are output from the drive ECU 23 through the output port. The drive ECU 23 sets a target gear stage M* by applying an accelerator operation amount Acc and a vehicle speed V to the gear change chart presented as an example in FIG. 2, and controls the automatic transmission such that a gear stage M of the automatic transmission of the automatic gear change device 22 becomes the target gear stage M*. In FIG. 2, the solid lines are gear change lines for upshifts and the broken lines are gear change lines for downshifts. The drive ECU 23 calculates a number of rotations N of the driveshaft 27 based on a rotation position θ from a rotation position detection sensor (not shown) mounted on the driveshaft 27. The drive ECU 23 communicates with the main ECU 30 through the communication port.

The brake device 24 is configured as a commonly known hydraulically driven brake device, and is configured to be able to apply a braking force attributable to a brake pressing force of a brake pedal 48 being pressed and a braking force attributable to adjustment of a hydraulic pressure to the drive wheels 29a, 29b and driven wheels 29c, 29d. The driving of the brake device 24 is controlled by a brake electronic control unit (hereinafter referred to as a “brake ECU”) 25. While this is not shown, the brake ECU 25 includes a microcomputer having a CPU, an ROM, an RAM, a flash memory, input and output ports, and a communication port. The brake ECU 25 performs control of the braking force attributable to the brake pressing force and the braking force attributable to adjustment of the hydraulic pressure that are applied by the brake device 24. The brake ECU 25 communicates with the main ECU 30 through the communication port.

The steering device 26 has a steering wheel (not shown) and the drive wheels 29a, 29b mechanically connected to each other through a steering shaft, and includes an actuator for steering. The steering device 26 steers the drive wheels 29a, 29b based on the driver's operation, and steers the drive wheels 29a, 29b by driving the actuator based on a steering signal from the main ECU 30.

The main ECU 30 includes a microcomputer having a CPU 31, an ROM 32, an RAM 33, a flash memory 34, and input and output ports and a communication port that are not shown. Signals from various sensors are input into the main ECU 30 through the input port. Examples of signals input into the main ECU 30 include an ignition signal from an ignition switch 40, the vehicle speed V from a vehicle speed sensor 41, each wheel speed from a wheel speed sensor 42, an acceleration a from an acceleration sensor 43, a yaw rate Yr from a yaw rate sensor 44, and a road surface gradient Or from a gradient sensor 45. Other examples are the accelerator operation amount Acc from an accelerator pedal position sensor 47 that detects an amount of pressing on an accelerator pedal 46, and a brake pedal position BP from a brake pedal position sensor 49 that detects an amount of pressing on the brake pedal 48. A further example is a travel mode DM from a travel mode switch 58. Travel modes DM include, other than a normal mode, an eco-mode in which acceleration is restricted to some extent to achieve better fuel consumption (or electric power consumption), and a sport mode, etc. in which acceleration is emphasized rather than the fuel consumption (or the electric power consumption).

Various control signals are output from the main ECU 30 through the output port. The control signals output from the main ECU 30 include a control signal to the steering device 26, an air-conditioning control signal to an air-conditioning device 29, a display control signal to a display device 70, and a communication control signal to a communication device 72. As described above, the main ECU 30 communicates with the drive ECU 23, the brake ECU 25, etc. through the communication port. Further, the main ECU 30 communicates with a shift electronic control unit (hereinafter referred to as a “shift ECU”) 50, a surroundings recognition electronic control unit (hereinafter referred to as a “surroundings recognition ECU”) 55, and a navigation device 60 through the communication port.

While this is not shown, the shift ECU 50 includes a microcomputer having a CPU, an ROM, an RAM, a flash memory, input and output ports, and a communication port. A shift position signal from a shift position sensor 52 that detects an operation position of a shift lever 51 is input into the shift ECU 50 through the input port. Shift positions include a parking position (P range), a neutral position (N range), a drive position (D range), a reverse position (R range), etc. The shift ECU 50 is connected to the surroundings recognition ECU 55 other than the main ECU 30 through the communication port, and sets the shift position based on the shift position signal from the shift position sensor 52 and a control signal from the surroundings recognition ECU 55, and transmits the set shift position to the main ECU 30.

While this is not shown, the surroundings recognition ECU 55 includes a microcomputer having a CPU, an ROM, an RAM, a flash memory, input and output ports, and a communication port. Various signals are input into the surroundings recognition ECU 55 through the input port. Examples of the signals input into the surroundings recognition ECU 55 include signals from the surroundings recognition device 56 showing information on the own vehicle and its surroundings (e.g., inter-vehicle distances D1, D2 between the own vehicle and vehicles on a front side and a rear side, and a traveling position of the own vehicle in a lane of a road, etc.), and an autonomous driving mode signal from an autonomous driving switch 57, etc. Examples of the surroundings recognition device 56 include a camera, a millimeter-wave radar, a quasi-millimeter-wave radar, an infrared laser radar, a sonar, etc. The autonomous driving switch 57 is a switch that switches among a fully autonomous driving mode in which all driving operations are autonomously performed, a semi-autonomous driving mode in which some of the driving operations are performed by the driver, and a manual driving mode in which the driver performs the driving operations. One example of the semi-autonomous driving mode is adaptive cruise control, etc. As described above, the surroundings recognition ECU 55 communicates with the main ECU 30 and the shift ECU 50 through the communication port.

The navigation device 60 includes a main body 62 incorporating a control unit, a GPS antenna 64 that receives information about a current location of the own vehicle, and a display 66. The control unit of the main body 62 has a storage medium (e.g., a hard disk, an SSD, etc.) in which map information and others are stored, input and output ports, and a communication port. In the map information, service information (e.g., sightseeing information, parking lots, etc.), road information on travel sections (e.g., between traffic lights and between intersections, etc.), etc. are stored as a database. The road information includes distance information, road width information, number-of-lanes information, area information (urban areas and suburban areas), type information (general roads and expressways), gradient information, legal speeds, the number of traffic lights, the turning radius of each curve, etc. The display 66 is configured as a touch panel-type display which displays various pieces of information such as information about the current location of the own vehicle and a planned travel route to a destination and into which the user can input various instructions. When the destination is set by the user's operation of the display 66, the main body 62 of the navigation device 60 sets a planned travel route from the current location of the own vehicle to the destination based on the map information stored in the main body 62, the current location of the own vehicle obtained from the GPS antenna 64, and the destination, and provides route guidance by displaying the set planned travel route on the display 66.

Next, the operation of the automobile 20 of the embodiment thus configured, particularly the operation when the automobile 20 travels by autonomous driving using the autonomous driving mode or the semi-autonomous driving mode will be described. FIG. 3 is a flowchart showing one example of a gear change selection process relating to a gear change of the automatic gear change device 22 that is executed by the main ECU 30. In the automobile 20 of the embodiment, when the automobile 20 is traveling by autonomous driving using the fully autonomous driving mode or the semi-autonomous driving mode, the main ECU 30 calculates a torque to be output to the driveshaft 27 for traveling according to a target vehicle speed V*, the vehicle speed V, the acceleration a, an inter-vehicle distance to a preceding vehicle, etc. and sets this torque as a required torque T*. Then, the main ECU 30 controls the drive device 21 and the automatic gear change device 22 such that the set required torque T* is output to the driveshaft 27.

When the gear change selection process is executed, the main ECU 30 determines whether the automobile 20 is driving autonomously (step S100) and whether the travel mode is the sport mode (step S110). Here, autonomous driving includes not only autonomous driving using the autonomous driving mode but also autonomous driving using the semi-autonomous driving mode. When the automobile 20 is not driving autonomously (when the automobile 20 is manually driven), or when the automobile 20 is driving autonomously but the travel mode is the sport mode, a normal gear change process using the gear change chart of FIG. 2 is selected (step S120), and the current process is ended.

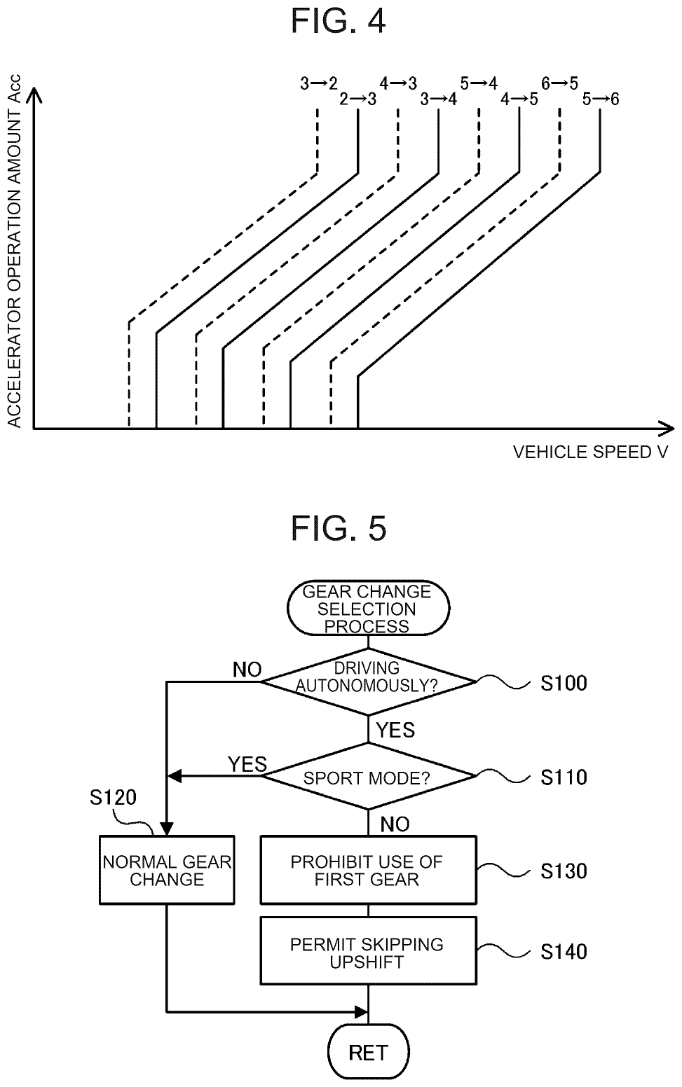

On the other hand, when it is determined that the automobile 20 is driving autonomously in step S100 and that the travel mode is not the sport mode in step S110, a process of prohibiting the use of the first gear stage among the gear stages of the automatic gear change device 22 is selected (step S130), and the current process is ended. As the process of prohibiting gear changes to and from the first gear stage, gear change control is performed using the gear stages of the second gear stage to the sixth gear stage as shown in the gear change chart presented as an example in FIG. 4. Gear change shocks that occur at the time of a gear change from the first gear stage to the second gear stage and a gear change from the second gear stage to the first gear stage with a high gear ratio are stronger than gear change shocks that occur at the time of gear changes to other gear stages. During autonomous driving that does not involve driving operations, due to higher sensory sensitivity compared with during manual driving, the driver feels gear change shocks more strongly. During autonomous driving in a travel mode other than the sport mode, the use of the first gear stage is prohibited to reduce such gear change shocks experienced by the driver. On the other hand, during autonomous driving in the sport mode, since the sport mode is a travel mode in which the driver enjoys high acceleration and shift shocks, a gear change from the first gear stage and a gear change to the first gear stage with a strong shift shock are permitted.

In the automobile 20 of the embodiment having been described above, when the automobile 20 is driving autonomously and the travel mode is not the sport mode, the use of the first gear stage among the gear stages of the automatic gear change device 22 is prohibited. Thus, a gear change shock experienced by the driver during autonomous driving can be reduced.

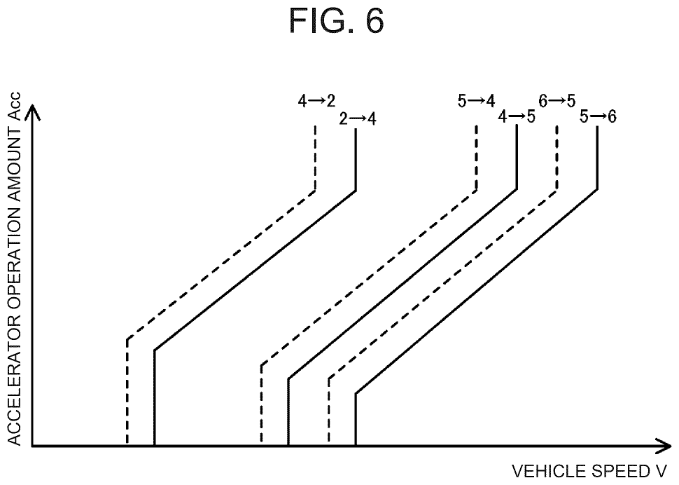

In the automobile 20 of the embodiment, when the automobile 20 is driving autonomously and the travel mode is not the sport mode, the use of the first gear stage among the gear stages of the automatic gear change device 22 is prohibited. In addition to this, a skipping upshift may be permitted. A gear change selection process in this case is shown in FIG. 5. In the gear change selection process of FIG. 5, when it is determined that the automobile 20 is driving autonomously in step S100 and that the travel mode is not the sport mode in step S110, the process of prohibiting the use of the first gear stage among the gear stages of the automatic gear change device 22 is selected (step S130) and a skipping upshift is permitted (step S140), and the current process is ended. In the skipping upshift, since the use of the first gear stage is prohibited, an upshift from the second gear stage to the fourth gear stage is performed. One example of the gear change chart when gear changes from and to the first gear stage are prohibited and a skipping upshift from second gear to fourth gear is permitted is shown in FIG. 6. In FIG. 6, not only a skipping upshift from second gear to fourth gear but also a skipping downshift from fourth gear to second gear is performed. Thus, the gear change chart of FIG. 6 means the same as that the use of the first gear stage and the third gear stage is prohibited. Thus, performing a skipping upshift can reduce the number of times of gear changes as well as reduce gear change shocks.

In the automobile 20 of the embodiment, the drive ECU 23 is used to control the drive device 21 and the automatic gear change device 22, and the brake ECU 25 is used to control the brake device 24. However, all or some of the functions of the drive ECU 23 or the brake ECU 25 may be performed by the main ECU 30.

Correspondence relationships between main elements of the embodiment and main elements of the disclosure will be described. In the embodiment, the surroundings recognition device 56 is one example of the “surroundings recognition device” of the present disclosure. The drive device 21 is one example of the “drive device” of the present disclosure. The automatic gear change device 22 is one example of the “automatic gear change device” of the present disclosure. The brake device 24 is one example of the “brake device” of the present disclosure. The drive ECU 23, the brake ECU 25, the main ECU 30, etc. are examples of the “controller” of the present disclosure.

The correspondence relationships between the main elements of the embodiment and the main elements of the disclosure are examples for specifically describing a mode for implementing the disclosure described in the section “SUMMARY” and therefore do not restrict the elements of the disclosure described in the section “SUMMARY”. Thus, the disclosure described in the section “SUMMARY” should be construed based on the description of that section, and the embodiment is merely one specific example of the disclosure described in the section “SUMMARY”.

While a mode for implementing the present disclosure has been described using the embodiment, it should be understood that the present disclosure is in no way limited to such an embodiment but can be implemented in various modes within such a range that no departure is made from the gist of the present disclosure.

The present disclosure can be used in the automobile manufacturing industry etc.

What is claimed is:

1. An automobile comprising:
a surroundings recognition device configured to acquire information on surroundings of a vehicle;
a drive device;
an automatic gear change device;
a brake device; and
a controller configured to control at least the drive device, the automatic gear change device, and the brake device such that the automobile travels by autonomous driving using information from the surroundings recognition device, wherein
the controller is configured to prohibit use of a predetermined low gear stage on a low-speed side in the automatic gear change device when the automobile travels by autonomous driving using a predetermined travel mode.

2. The automobile according to claim 1, wherein the surroundings recognition device includes one or more than one among a camera, a millimeter-wave radar, a quasi-millimeter-wave radar, an infrared laser radar, and a sonar.

3. The automobile according to claim 1, wherein:
the predetermined travel mode is a travel mode other than a sport mode; and
the predetermined low gear stage is a first gear stage.

4. The automobile according to claim 1, wherein the controller is configured to permit a skipping upshift in the automatic gear change device when the automobile travels by autonomous driving using the predetermined travel mode.

5. A control method of an automobile including a surroundings recognition device configured to acquire information on surroundings of a vehicle, a drive device, an automatic gear change device, and a brake device, comprising:
controlling at least the drive device, the automatic gear change device, and the brake device such that the automobile travels by autonomous driving using information from the surroundings recognition device; and
prohibiting use of a predetermined low gear stage on a low-speed side in the automatic gear change device when the automobile travels by autonomous driving using a predetermined travel mode.
